(19) United States
(12) Patent Application Publication
(10) Pub. No.: US 2025/0370520 A1
(43) Pub. Date: Dec. 4, 2025

(54) CONTROL CIRCUIT AND CONTROL METHOD THEREOF

(71) Applicant: Coretronic Corporation, Hsin-Chu (TW)

(72) Inventors: You-Xuan Kuo, Hsin-Chu (TW); Jeng-An Liao, Hsin-Chu (TW)

(73) Assignee: Coretronic Corporation, Hsin-Chu (TW)

(21) Appl. No.: 19/216,685

(22) Filed: May 22, 2025

(30) Foreign Application Priority Data
May 30, 2024 (CN) 202410686038.2

(51) Int. Cl. G06F 1/26; G06F 8/65

(52) U.S. Cl. CPC G06F 1/26; G06F 8/65

(57) ABSTRACT

A control circuit and control a method thereof are provided. After a first circuit provides a first signal to a preset pin of a second circuit, the first circuit controls a switch unit to convert a first voltage from a power converter into a third voltage to be provided to the second circuit, so as to activate the second circuit to enter a firmware update mode in response to the first signal.

### CROSS-REFERENCE TO RELATED APPLICATION

This application claims the priority benefit of China application serial no. 202410686038.2, filed on May 30, 2024. The entirety of the above-mentioned patent application is hereby incorporated by reference herein and made a part of this specification.

### BACKGROUND OF THE INVENTION

### Field of the Invention

The invention relates to an electronic device, and in particular, to a control circuit of the electronic device and a control method thereof.

### Description of Related Art

In the prior art, a projection device often adopts an application-specific chip (ASICs) made by MediaTek (MTK) to implement a multimedia application function, and implement the functions of an image receiver, an audio amplifier, and a microcontroller (MCU). In addition, the projection device is also equipped with an application-specific chip (ASIC) made by Texas Instruments to control, for example, a DMD (digital micro-mirror device) chip, a lamp, and a fan. When using these two special application chips together, how to prevent errors causing the system of the projection device to crash is an important issue.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY OF THE INVENTION

The invention provides a control circuit and a control method thereof that may effectively prevent errors of the control circuit causing the system of the projection device to crash.

Other objects and advantages of the invention may be further understood from the technical features disclosed in the invention.

In order to achieve one, part, or all of the above objects or other objects, an embodiment of the invention provides a control circuit. The control circuit includes a power converter, a switch unit, a first circuit, and a second circuit, wherein the first circuit is coupled to the power converter, the second circuit, and the switch unit, and the switch unit is coupled between the power converter and the second circuit. The switch unit is configured to turn on or turn off the power supply path between the power converter and the second circuit. The first circuit is configured to receive a firmware update command and control the power converter to provide a first voltage to the switch unit according to the firmware update command, and the first circuit performs an initial setting. The first circuit provides a first signal to a preset pin of the second circuit after completing the initial setting. After the first circuit provides the first signal to the second circuit, the first circuit controls the switch unit to turn on the power supply path between the power converter and the second circuit, so that the switch unit converts the first voltage from the power converter into a third voltage to be provided to the second circuit, so that the second circuit is activated, and after being activated, the second circuit receives the first signal from the first circuit and enters a firmware update mode.

The invention also provides a control method of a control circuit. The control circuit includes a power converter, a switch unit, a first circuit, and a second circuit. The first circuit is coupled to the power converter, the second circuit, and the switch unit, and the switch unit is coupled between the power converter and the second circuit to turn on or turn off a power supply path between the power converter and the second circuit. The control method includes the following steps. The first circuit is configured to receive a firmware update command and control the power converter to provide a first voltage to the switch unit according to the firmware update command, and the first circuit performs an initial setting. The first circuit provides a first signal to a preset pin of the second circuit after completing the initial setting. After the first circuit provides the first signal to the second circuit, the first circuit controls the switch unit to turn on the path between the power converter and the second circuit. The switch unit is made to convert the first voltage from the power converter into a third voltage to be provided to the second circuit to activate the second circuit, and after being activated, the second circuit receives the first signal from the first circuit and enters a firmware update mode.

Based on the above, after the first circuit of an embodiment of the invention provides the first signal to the preset pin of the second circuit, the first circuit may control the switch unit to convert the first voltage from the power converter into the third voltage to be provided to the second circuit to activate the second circuit to enter the firmware update mode in response to the first signal. As a result, the second circuit may be effectively prevented from receiving the first signal from the preset pin too late and causing errors and thereby causing the system of the projection device to crash.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic diagram of a control circuit according to an embodiment of the invention.

FIG. 2 is a schematic diagram of the working sequence of a control circuit according to an embodiment of the invention.

FIG. 3 is an operation timing diagram of a control circuit according to an embodiment of the invention.

FIG. 4A is an activation flowchart of a microcontroller of a first circuit according to an embodiment of the invention.

FIG. 4B is an activation flowchart of a second circuit according to an embodiment of the invention.

FIG. 5 is a flowchart of a control method of a control circuit according to an embodiment of the invention.

FIG. 6 is a detailed flowchart of a control method of a control circuit according to an embodiment of the invention.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

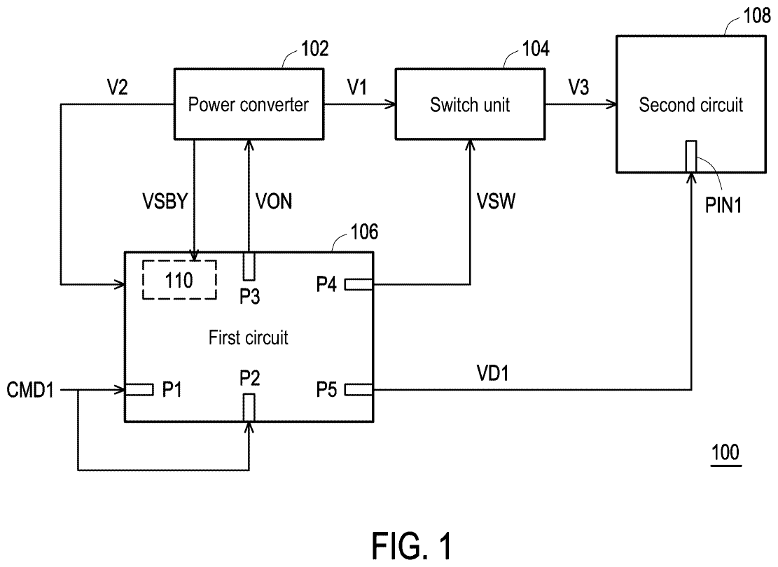

FIG. 1 is a schematic diagram of a control circuit according to an embodiment of the invention. Please refer to FIG. 1. A control circuit 100 is suitable for a projection device, and may include a power converter 102, a switch unit 104, a first circuit 106, and a second circuit 108. In particular, the power converter 102 may be, for example, a power supply well known to those skilled in the art, and the first circuit 106 may be a display control single chip (such as an MT9266 chip), and the second circuit 108 may be a digital optical processing chip (such as a DDP442X chip), but the invention is not limited thereto. The first circuit 106 has at least one first input/output pins P1 and P2 and a second input/output pin P3, wherein the first input/output pins P1 and P2 and the second input/output pin P3 may be defined as the same input/output pins P1 to P3. The first circuit 106 also has a third input/output pin P4 and a fourth input/output pin P5, and the third input/output pin P4 and the fourth input/output pin P5 may be defined as the same input/output pins P4 and P5. It should be noted that the input/output pins are, for example, general-purpose input/output (GPIO) known to those skilled in the art. The first circuit 106 is coupled to the power converter 102 via the second input/output pin P3, the first circuit 106 is coupled to the switch unit 104 via the third input/output pin P4, the first circuit 106 is coupled to a preset pin PIN1 of the second circuit 108 via the fourth input/output pin P5, and the switch unit 104 is coupled between the power converter 102 and the second circuit 108 to turn on or turn off the power supply path between the power converter 102 and the second circuit 108. The switch unit 104 may be implemented, for example, with a metal oxide semiconductor field-effect transistor (MOSFET) or a bipolar junction transistor (BJT). However, any element that may function as a switch is applicable to the present application and is not limited thereto. In particular, in a case that power is provided to the control circuit 100 but the control circuit 100 is not activated, the first input/output pins P1 and P2 and the second input/output pin P3 may be detected and controlled, and the third input/output pin P4 and the fourth input/output pin P5 may be detected or controlled only in a case that power is provided to the control circuit 100 and the control circuit 100 is activated. For example, when the projection device includes the control circuit 100, the method in which power is provided to the control circuit 100 is, for example, by plugging a power cord into the projection device so that the control circuit 100 obtains power. If the user does not press the power button of the projection device, the control circuit 100 has not yet entered standby mode, and the control circuit 100 is not activated and performs basic work with a standby voltage of, for example, 5 V. For example, the standby indicator light is displayed or the infrared module is placed in standby mode. In this standby mode, the first input/output pins P1 and P2 and the second input/output pin P3 are detected and controlled. After the power cord is plugged into the projection device, for example, when the user presses the power button of the projection device, the control circuit 100 may enter working mode. When the control circuit 100 is activated, the control circuit 100 may work normally with a working voltage of, for example, 12 V. Only in this working mode may the third input/output pin P4 and the fourth input/output pin P5 be detected or controlled.

The first circuit 106 may receive a firmware update command CMD1 via the at least one first input/output pin P1 and P2. The first circuit 106 controls the power converter 102 to provide a first voltage V1 to the switch unit 104 and provide a second voltage V2 to the first circuit 106 according to the firmware update command CMD1. After receiving the second voltage V2, the first circuit 106 performs an initial setting, wherein the initial setting may be, for example, mute or sound level setting. In particular, the firmware update command CMD1 is generated, for example, by the user pressing and holding the power button and the menu button of the projection device corresponding to the at least one first input/output pin P1 and P2, then plugging the power cord into the projection device, thereby making the first circuit 106 receive the firmware update command CMD1. Further, the first circuit 106 may include a microcontroller 110. After a button corresponding to the at least one first input/output pin P1 and P2 (such as the power button and the menu button) is pressed, a power cord is plugged into the projection device, so that power may be provided to the control circuit 100, so that the first circuit 106 may receive the firmware update command CMD1, and the power converter 102 may be controlled to provide an activation voltage VSBY to the microcontroller 110. At this time, in standby mode, the microcontroller 110 may control the first circuit 106 to output a power control signal VON from the second input/output pin P3 to the power converter 102 (as shown in FIG. 1) to control the power converter 102 to provide the first voltage V1 to the switch unit 104 and control the power converter 102 to provide the second voltage V2 to the first circuit 106, wherein the first voltage V1 and the second voltage V2 may, for example, have the same voltage value, but the invention is not limited thereto.

In some embodiments, the method of generating the firmware update command CMD1 is not limited to using the power button and the menu button. A combination of other buttons may also be used, or only a single button may be used. That is, in other embodiments, the firmware update command CMD1 may also be received via at least one of the first input/output pins P1 and P2, or more input/output pins that may be detected and controlled in standby mode.

Please continue to refer to FIG. 1. In the present embodiment, the first circuit 106 receives the second voltage V2 from the power converter 102 and performs an initial setting. After completing the initial setting, the first circuit 106 provides a first signal VD1. That is, after the first circuit 106 completes the initial setting, the first circuit 106 may provide the first signal VD1 to the preset pin PIN1 of the second circuit 108, wherein the level of the first signal VD1 provided to the second circuit 108 may be, for example, a low-voltage logic level, but the invention is not limited thereto. After the first circuit 106 provides the first signal VD1 to the second circuit 108, the first circuit 106 controls the switch unit 104 to turn on the power supply path between the power converter 102 and the second circuit 108, so that the switch unit 104 converts the first voltage V1 from the power converter 102 into a third voltage V3, and provides the third voltage V3 to the second circuit 108 to activate the second circuit 108. After being activated, the second circuit 108 may receive the first signal VD1 from the first circuit 106 and enter the firmware update mode.

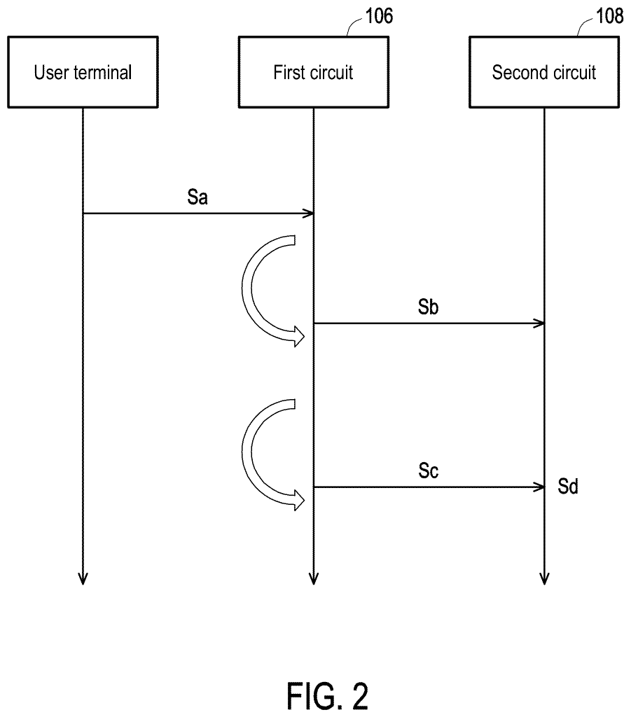

FIG. 2 is a schematic diagram of the working sequence of a control circuit according to an embodiment of the invention. Please refer to FIG. 2 in conjunction with FIG. 1. In the present embodiment, when the user presses and holds the power button and the menu button of the projection device corresponding to the at least one first input/output pin P1 and P2, and then plugs a power cord into the projection device, the first circuit 106 may receive the firmware update command CMD1, so that the first circuit 106 outputs the power control signal VON to the power converter 102 from the second input/output pin P3 to control the power converter 102 to provide the second voltage V2 to the first circuit 106 to perform an initial setting, as shown in a process Sa. After the first circuit 106 completes the initial setting, the first circuit 106 may provide the first signal VD1 to the preset pin PIN1 of the second circuit 108, so that the preset pin PIN1 of the second circuit 108 may be set to the level of the first signal VD1 (low-voltage logic level), as shown in a process Sb. Then, as shown in a process Sc, the first circuit 106 controls the switch unit 104 to turn on the power supply path between the power converter 102 and the second circuit 108, so that the switch unit 104 converts the first voltage V1 from the power converter 102 into the third voltage V3, and provides the third voltage V3 to the second circuit 108 to activate the second circuit 108. After being activated, the second circuit 108 may receive the first signal VD1 from the first circuit 106 and enter the firmware update mode, as shown in a process Sd.

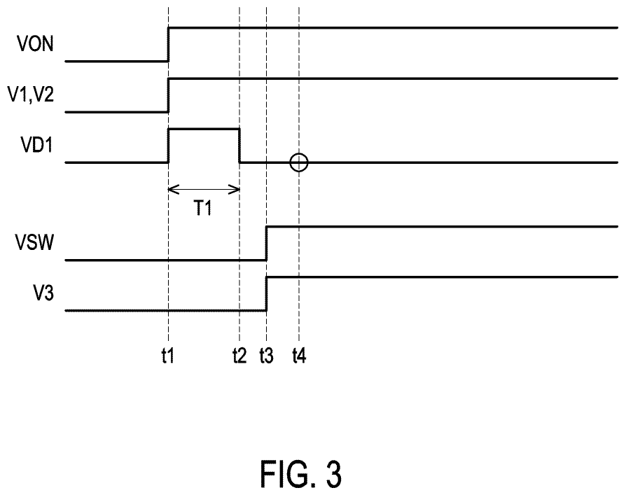

FIG. 3 is an operation timing diagram of a control circuit according to an embodiment of the invention. Please refer to FIG. 1, FIG. 2, and FIG. 3 at the same time. At a time point t1, the first circuit 106 outputs the power control signal VON from the second input/output pin P3 to the power converter 102 to control the power converter 102 to provide the first voltage V1 to the switch unit 104, and control the power converter 102 to provide the second voltage V2 to the first circuit 106. As shown in FIG. 3, the first circuit 106 performs an initial setting during a period T1 corresponding to times t1 to t2, so that the first signal VD1 generates a first level, wherein the first level may be, for example, a high-voltage logic level at the times t1 to t2, so that the first circuit 106 may perform the initial setting, and after the first circuit 106 completes the initial setting, for example, the initial setting is completed at the time point t2, the first circuit 106 changes the first level to a second level, wherein the second level is, for example, a low-voltage logic level, whereby the preset pin PIN1 of the second circuit 108 may enter the firmware update mode when receiving the first signal VD1 corresponding to the second level.

Please continue to refer to FIG. 3. After the first circuit 106 provides the first signal VD1 corresponding to the second level to the second circuit 108, the first circuit 106 may provide a switch control signal VSW to the switch unit 104 at a time point t3 to control the switch unit 104 to turn on the power supply path between the power converter 102 and the second circuit 108, so that the switch unit 104 converts the first voltage V1 from the power converter 102 into the third voltage V3, and provides the third voltage V3 to the second circuit 108, thereby activating the second circuit 108. After being activated, the second circuit 108 may receive the first signal VD1 corresponding to the second level from the first circuit 106, such as a time point t4, so that the firmware update mode may be entered by setting the default pin PIN1 of the second circuit 108 to the level of the first signal VD1 (low-voltage logic level). In particular, the firmware update mode may be used, for example, to update the color, brightness, speaker parameters, and light valve control settings of the projection device, but the invention is not limited thereto.

In this way, the first signal VD1 is provided to the preset pin PIN1 of the second circuit 108 first, and only then is the switch unit 104 controlled to convert the first voltage V1 into the third voltage V3 to be provided to the second circuit 108, thus effectively preventing errors of the second circuit 108 due to receiving the first signal VD1 of the preset pin PIN1 too late and causing the system of the projection device to crash.

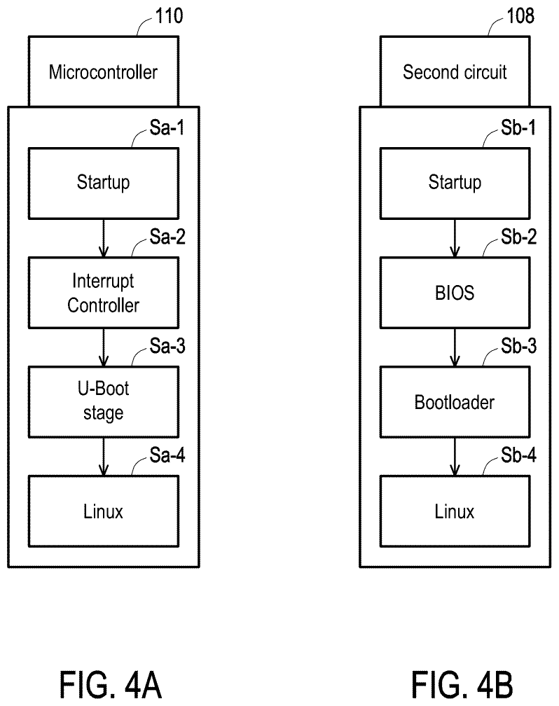

FIG. 4A is an activation flowchart of a microcontroller of a first circuit according to an embodiment of the invention, and FIG. 4B is an activation flowchart of a second circuit according to an embodiment of the invention. As shown in FIG. 4A, after receiving the second voltage V2 provided by the power converter 102, the microcontroller 110 of the first circuit 106 is activated in step Sa-1. After activation, as shown in step Sa-2, an interrupt controller in the microcontroller 110 may keep the microcontroller 110 in an interrupt control state, and then step Sa-3 may be entered, so that after the microcontroller 110 enters the initial setting stage (U-Boot stage), an initial setting is performed. After the initial setting of the microcontroller 110 is completed, step Sa-4 may be performed to enter the operating system. The operating system is, for example, a Linux operating system. The microcontroller 110 of the first circuit 106 may provide the first signal VD1 to the preset pin PIN1 of the second circuit 108 after executing the activation process as shown in FIG. 4A and completing the initial setting. At this time, the switch unit 104 has not yet provided the third voltage V3 to the second circuit 108, that is, the second circuit 108 has not yet started the activation process of FIG. 4B. When the switch unit 104 provides the third voltage V3 to the second circuit 108, the second circuit 108 enters step Sb-1 for activation. After activation, as shown in step Sb-2, the basic input/output system (BIOS) is entered for basic settings. Next, as shown in step Sb-3, the activation stage mode (Bootloader) is entered. Since the first signal VD1 from the first circuit 106 is provided to the preset pin PIN1 of the second circuit 108 first, the first signal VD1 may be received at the moment when the second circuit 108 is operated, and therefore the operating system (Linux operating system) is not entered as in step Sb-4. In other words, in the activation stage mode (Bootloader), the second circuit 108 receives the preset pin PIN1 and is therefore set to the level corresponding to the first signal VD1 (low-voltage logic level), so as to enter the firmware update mode. Please refer further to FIG. 3. When the second circuit 108 enters the activation stage mode (Bootloader) at the time point t4, the preset pin PIN1 of the second circuit 108 is set to the level corresponding to the first signal VD1 (low-voltage logic level). As a result, the second circuit 108 may be effectively prevented from receiving the first signal VD1 from the preset pin PIN1 too late and causing errors and thereby causing the system of the projection device to crash.

In addition, the above embodiments only need to adopt one microcontroller 110 to effectively ensure that the second circuit 108 may smoothly perform firmware update to prevent errors of the first circuit 106 with the second circuit 108 before the initial setting is completed, without using a plurality of microcontrollers. Therefore, costs may be effectively reduced, and the update process is controlled only via the microcontroller 110 of the first circuit 106 without other microcontrollers, so as to simplify software and hardware design and control method.

Moreover, since, when providing the first signal VD1 and providing the switch control signal VSW, the first circuit 106 of the above embodiments does not make the second circuit 108 enter the firmware update mode using the input/output pins that may be detected or controlled only in a case that power is provided to the control circuit 100 without activation (for example, similar to the first input/output pins P1 and P2 and the second input/output pin P3), the input/output pins that may be detected and controlled in a case that power is provided to the control circuit 100 without activation may be reserved for other applications, for example, infrared detection, Wi-Fi wake-up, controlling the behavior of LED lights in standby mode, or applications that use digital-analog keys (ADC-KEY) to connect reserved input/output pins in parallel, so that the design of the control circuit 100 is more flexible. The above applications are only examples and do not limit the scope of applications.

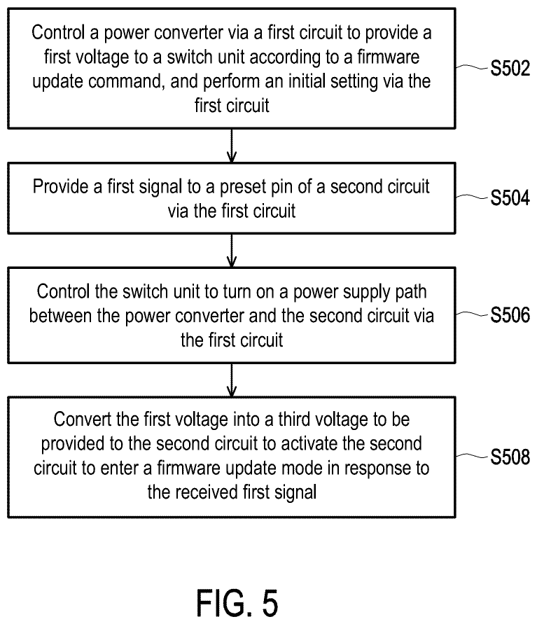

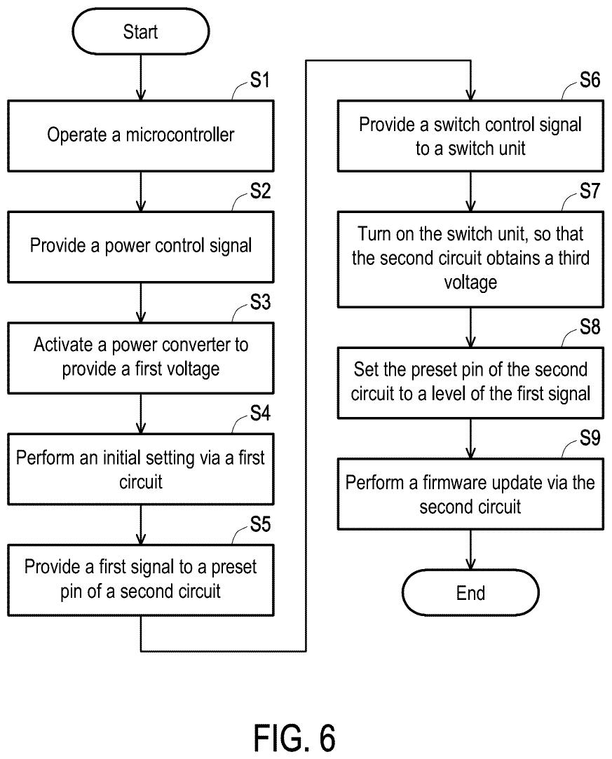

FIG. 5 is a flowchart of a control method of a control circuit according to an embodiment of the invention, wherein the control circuit is suitable for a projection device. The control circuit may include a power converter, a switch unit, a first circuit, and a second circuit, the first circuit is coupled to the power converter, the second circuit, and the switch unit, the switch unit is coupled between the power converter and the second circuit, and the switch unit is configured to turn on or turn off the power supply path between the power converter and the second circuit. It may be known from the above embodiments that the control method of the control circuit may include at least the following steps. First, a firmware update command is received via the first circuit and the power converter is controlled to provide a first voltage to the switch unit according to the firmware update command, and the first circuit performs an initial setting (step S502). After the first circuit completes the initial setting, the first circuit provides a first signal to a preset pin of the second circuit (step S504). The level corresponding to the first signal may be, for example, a low-voltage logic level, but the invention is not limited thereto. After the first circuit provides the first signal to the second circuit, the first circuit controls the switch unit to turn on the power supply path between the power converter and the second circuit (step S506), so that the switch unit converts the first voltage from the power converter into a third voltage to be provided to the second circuit, so that the second circuit is activated, and after being activated, the second circuit receives the first signal from the first circuit and enters a firmware update mode (step S508). In detail, a control method of a control circuit may be shown in FIG. 6. FIG. 6 is a detailed flowchart of a control method of a control circuit according to an embodiment of the invention. Please refer to FIG. 6 in conjunction with FIG. 1. After the power button and the menu button of the projection device are pressed, a power cord is plugged into the projection device, so that power is provided to the control circuit 100, and the first circuit 106 receives the firmware update command CMD1, and the power converter 102 is controlled to provide the activation voltage VSBY to the microcontroller 110, so that the microcontroller 110 starts to operate (e.g., step S1). Specifically, after a button corresponding to the at least one first input/output pin P1 and P2 (such as the power button and the menu button) is pressed, a power cord is plugged into the projection device, so that power may be provided to the control circuit 100, so that the first circuit 106 may receive the firmware update command CMD1, and the power converter 102 may provide the activation voltage VSBY to the microcontroller 110.

Then in step S2, the microcontroller 110 outputs the power control signal VON from the second input/output pin P3 to the power converter 102 according to the command preset by the setting personnel to activate the power converter 102, so that the power converter 102 provides the first voltage V1 to the switch unit 104 (step S3), and the first circuit 106 performs an initial setting (step S4). Furthermore, the first circuit 106 may also control the power converter 102 to provide the second voltage V2, and the first circuit 106 performs an initial setting after receiving the second voltage V2 from the power converter 102. After completing the initial setting, the first circuit 106 provides the first signal VD1 from the first circuit 106 to the preset pin PIN1 of the second circuit 108 according to the command preset by the setting personnel (step S5).

After providing the first signal VD1 to the second circuit 108, according to the command preset by the setting personnel, the first circuit 106 may provide the switch control signal VSW to the switch unit 104 (step S6) to control the switch unit 104 to turn on the power supply path between the power converter 102 and the second circuit 108, so that the switch unit 104 converts the first voltage V1 from the power converter 102 into the third voltage V3, and provides the third voltage V3 to the second circuit 108, so that the second circuit 108 obtains the third voltage V3 (step S7). After the second circuit 108 obtains the third voltage V3, the second circuit 108 receives the first signal VD1 on the preset pin PIN1, so that the preset pin PIN1 of the second circuit 108 is set to the level of the first signal VD1 (low-voltage logic level) (step S8), so that the second circuit 108 enters the firmware update mode to perform firmware update (step S9). Furthermore, the first circuit 106 may make the first signal VD1 generate a first level when starting the initial setting, and after the first circuit 106 completes the initial setting, the first level is changed to a second level, so that the default pin PIN1 of the second circuit 108 enters the firmware update mode when receiving the first signal VD1 corresponding to the second level.

Based on the above, after the first circuit of an embodiment of the invention provides the first signal to the preset pin of the second circuit, the first circuit may control the switch unit to provide the first voltage from the power converter to the second circuit to activate the second circuit to enter the firmware update mode in response to the first signal. As a result, the second circuit may be effectively prevented from receiving the first signal from the preset pin too late and causing errors and thereby causing the system of the projection device to crash. Moreover, when providing the first signal VD1 and providing the switch control signal VSW, the first circuit does not make the second circuit enter the firmware update mode using the input/output pins that may be detected or controlled only in a case that power is provided to the control circuit without activation (for example, similar to the first input/output pins P1 and P2 and the second input/output pin P3), and therefore the input/output pins that may be detected and controlled in a case that power is provided to the control circuit without activation may be reserved for other applications, so that the design of the control circuit 100 is more flexible.

However, the above are only preferred embodiments of the invention, and should not be used to limit the scope of the invention. That is, all simple equivalent changes and modifications made based on the claims of the invention and the specification content of the invention are still within the scope of the patent of the invention. In addition, any embodiment or patentable scope of the invention does not need to achieve all the objects, advantages, or features disclosed in the invention. In addition, the abstract section and the title are only used to assist in searching patent documents and are not intended to limit the scope of the invention. Furthermore, the first, second, etc. mentioned in the specification are only used to indicate the names of elements and are not used to limit the upper limit or the lower limit of the number of elements.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A control circuit, wherein the control circuit comprises a power converter, a switch unit, a first circuit, and a second circuit, wherein,
the first circuit is coupled to the power converter, the second circuit, and the switch unit;
the switch unit is coupled between the power converter and the second circuit and configured to turn on or turn off a power supply path between the power converter and the second circuit;
wherein the first circuit is configured to receive a firmware update command and control the power converter to provide a first voltage to the switch unit according to the firmware update command, and the first circuit performs an initial setting;
the first circuit provides a first signal to a preset pin of the second circuit after completing the initial setting; and
after the first circuit provides the first signal to the second circuit, the first circuit controls the switch unit to turn on the power supply path between the power converter and the second circuit, so that the switch unit converts the first voltage from the power converter into a third voltage to be provided to the second circuit, so that the second circuit is activated, and after being activated, the second circuit receives the first signal from the first circuit and enters a firmware update mode.

2. The control circuit of claim 1, wherein the first circuit is configured to receive a second voltage from the power converter to perform the initial setting, and the first circuit provides the first signal after completing the initial setting.

3. The control circuit of claim 2, wherein the first circuit comprises a microcontroller, at least one first input/output pin, and a second input/output pin, after a button corresponding to the at least one first input/output pin is pressed, a power supply is provided to the control circuit, so that the first circuit receives the firmware update command, and the power converter provides an activation voltage to the microcontroller, and at this time, the microcontroller outputs a power control signal from the second input/output pin to the power converter to control the power converter to provide the first voltage and the second voltage.

4. The control circuit of claim 3, wherein the first circuit also comprises a third input/output pin and a fourth input/output pin, the third input/output pin is coupled to the switch unit, and the fourth input/output pin is coupled to the preset pin, wherein in a case that the power supply is provided to the control circuit but the control circuit is not activated, the at least one first input/output pin and the second input/output pin may be detected and controlled, and the third input/output pin and the fourth input/output pin may only be detected or controlled in a case that the power supply is provided to the control circuit and the control circuit is activated.

5. The control circuit of claim 1, wherein the first circuit is a display control single chip, and the second circuit is a digital optical processing chip.

6. The control circuit of claim 1, wherein when the first circuit starts to perform the initial setting, the first signal generates a first level, and after the first circuit completes the initial setting, the first level is changed to a second level, so that the preset pin of the second circuit enters the firmware update mode when receiving the first signal corresponding to the second level.

7. The control circuit of claim 1, wherein after the first circuit provides the first signal to the second circuit, the first circuit provides a switch control signal to the switch unit, so that the switch unit turns on the power supply path between the power converter and the second circuit.

8. A control method of a control circuit, wherein the control circuit comprises a power converter, a switch unit, a first circuit, and a second circuit, the first circuit is coupled to the power converter, the second circuit, and the switch unit, and the switch unit is coupled between the power converter and the second circuit to turn on or turn off a power supply path between the power converter and the second circuit, and the control method comprises:
receiving a firmware update command via the first circuit and controlling the power converter to provide a first voltage to the switch unit according to the firmware update command, and performing an initial setting via the first circuit;
providing a first signal to a preset pin of the second circuit after the first circuit completes the initial setting;
controlling the switch unit to turn on the power supply path between the power converter and the second circuit via the first circuit after the first circuit provides the first signal to the second circuit; and
making the switch unit convert the first voltage from the power converter into a third voltage to be provided to the second circuit to activate the second circuit, and after being activated, the second circuit receives the first signal from the first circuit and enters a firmware update mode.

9. The control method of claim 8, further comprising:
receiving a second voltage from the power converter via the first circuit to perform the initial setting, and providing the first signal after the initial setting is completed.

10. The control method of claim 9, wherein the first circuit comprises a microcontroller, at least one first input/output pin, and a second input/output pin, and the control method further comprises:
providing a power supply to the control circuit after a button corresponding to the at least one first input/output pin is pressed, so that the first circuit receives the firmware update command and the power converter provides an activation voltage to the microcontroller; and
outputting a power control signal from the second input/output pin to the power converter via the microcontroller to control the power converter to provide the first voltage and the second voltage.

11. The control method of claim 10, wherein the first circuit also comprises a third input/output pin and a fourth input/output pin, the third input/output pin is coupled to the switch unit, and the fourth input/output pin is coupled to the preset pin, wherein in a case that the power supply is provided to the control circuit but the control circuit is not activated, the at least one first input/output pin and the second input/output pin may be detected and controlled, and the third input/output pin and the fourth input/output pin may only be detected or controlled in a case that the power supply is provided to the control circuit and the control circuit is activated.

12. The control method of claim 8, wherein the first circuit is a display control single chip, and the second circuit is a digital optical processing chip.

13. The control method of claim 8, wherein the control method comprises:
controlling the first circuit to make the first signal generate a first level when starting the initial setting, and after the first circuit completes the initial setting, the first level is changed to a second level, so that the preset pin of the second circuit enters the firmware update mode when receiving the first signal corresponding to the second level.

14. The control method of claim 8, wherein after the first circuit provides the first signal to the second circuit, the first circuit provides a switch control signal to the switch unit, so that the switch unit turns on the power supply path between the power converter and the second circuit.
